(19) United States
(12) Patent Application Publication
(10) Pub. No.: US 2003/0236073 A1
(43) Pub. Date: Dec. 25, 2003

(54) Correction of mismatch between in-phase and quadrature signals in a radio receiver

(76) Inventor: Gunnar Wetzker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/377,238

(22) Filed: Feb. 28, 2003

(30) Foreign Application Priority Data
Mar. 5, 2002 (EP) 02075848.8

(51) Int. Cl. H04B 17/00

(52) U.S. Cl. 455/67.11; 455/67.13

(57) ABSTRACT

The present invention relates to a circuit for estimating and correcting mismatch between incoming in-phase and quadrature signals. The basic idea is to modify the approaches as known from U.S. Pat. No. 5,230,099 and [1] by:

combining the best performing errors signal ([1]) with the cheapest to implement correction system (U.S. Pat. No. 5,230,099);

letting the detector output a positive center frequency and a negative center frequency corresponding to a center frequency of the stronger of at least two signals at respective frequencies;

up-mixing and low pass filtering the regulated in-phase and quadrature signals, using the positive center frequency as mixing frequency;

down-mixing and low pass filtering the regulated in-phase and quadrature signals, using the negative center frequency as mixing frequency;

expanding the automatic gain control to operate on up-mixed filtered and down-mixed filtered regulated in-phase and quadrature signals;

expanding the error signal calculator to operate on up-mixed filtered normalized and down-mixed filtered regulated normalized in-phase and quadrature signals.

Neighbor channel disturbance entering the circuit is thereby reduced, and the stability and the overall performance of the circuit improved.

The present invention relates to a circuit for estimating and correcting mismatch between incoming in-phase and quadrature signals, the circuit comprising:

a detector for detecting a center frequency of the stronger of at least two signals at respective frequencies;

an automatic gain control element for receiving and normalizing low-pass filtered up-mixed regulated in-phase and quadrature signals and for receiving and normalizing low-pass filtered down-mixed regulated in-phase and quadrature signals;

an error signal calculator for calculating an amplitude error signal and for calculating a phase error signal from the normalized low-pass filtered up-mixed regulated in-phase and quadrature signals and from the normalized low-pass filtered down-mixed regulated in-phase and quadrature signals;

a first loop filter for low pass filtering the amplitude error signal;

a second loop filter for low pass filtering the phase error signal;

a minimum correction system for correcting the amplitude and phase of in-phase and quadrature signals, the minimum correction system receiving the low pass filtered amplitude error signal, and the minimum correction system receiving the low pass filtered phase error signal;

an estimation control element for receiving the low pass filtered amplitude error signal and for receiving the low pass filtered phase error signal, the estimation control element for resetting, if the amplitude error signal reaches a first predefined limit, at least the filter filtering the amplitude error signal, and for resetting, if the phase error signal reaches a second predefined limit, at least the filter filtering the phase error signal.

The field of use for this invention are receivers in general; frequency modulated (FM), phase modulated (PM) or amplitude modulated (AM). Examples of products are stationary radios, automobile radios, mobile radios, televisions (TV), mobile telephones etc.

U.S. Pat. No. 5,230,099 describes a system for detecting and controlling gain and phase errors in a direct conversion receiver having a pair of signal channels carrying I and Q base-band signal components which are in quadrature and are a function of a phase angle θ. The system operates by generating Iₘᵢₙ and Qₘᵢₙ signals, which correspond to sin(2θ) and cos(2θ). These Iₘᵢₙ and Qₘᵢₙ signals are then normalized with respect to signal amplitude and filtered to produce signals DC_{I} and DC_{Q} corresponding to their DC components. The resulting signals DC_{I} and DC_{Q} have been discovered to be separately correlated with the gain (g) and phase (p) errors, respectively, and are used in adjusting the original I and Q base-band signal components I and Q to correct for any such errors existing between them.

U.S. Pat. No. 5,230,099 uses a cross-correlation operation between in-phase and quadrature signals to derive the phase error-signal and an energy comparison of in-phase and quadrature signals to derive an amplitude error signal. Instead in [1] a complex error-signal is used, which leads to better results in terms of minimization of amplitude and phase mismatch between the real and imaginary part in the complex signal. As a disadvantage, in [1] a correction system is used which is costly to implement, whereas U.S. Pat. No. 5,230,099 uses a much less costly approach. By combining the complex error signal from [1] with the correction system of U.S. Pat. No. 5,230,099 a system results which leads to better performance compared to U.S. Pat. No. 5,230,099 and is less costly in terms of implementation costs than [1]. Furthermore, a number of features are added to improve and keep control of performance beyond what is known from U.S. Pat. No. 5,230,099 and [1].

Reference:

[1] Yu and Snelgrove: A Novel Adaptive Mismatch Cancellation System, IEEE Transactions On Circuits And Systems—II: Analog And Digital Signal Processing, vol. 46, no. 6, June 1999, p. 789-801.

An objective of the present invention is to provide an improved minimization of amplitude and phase mismatch between real and imaginary parts in a complex signal, preferably close to zero mismatch.

This is, as disclosed in claim 1, achieved according to the invention by that said detector is adapted for outputting a positive center frequency and outputting a negative center frequency corresponding to said detected center frequency, and said minimum correction system is adapted for correcting the amplitude and phase of the incoming in-phase and quadrature signals to form the regulated in-phase and quadrature signals, and the circuit comprises:

a first mixer for up-mixing regulated in-phase and quadrature signals with a positive center frequency outputted from the detector;

a second mixer for down-mixing the regulated in-phase and quadrature signals with a negative center frequency outputted from the detector;

a first pair of low-pass filters for receiving and filtering the up-mixed regulated in-phase and quadrature signals;

a second pair of low-pass filters for receiving and filtering the down-mixed regulated in-phase and quadrature signals.

Hereby it is ensured that the minimum correction system is operating at the input signal to the circuit. The mismatch between the regulated in-phase and quadrature signals inside the circuit is therefore cancelled out before the up-mixing and down-mixing processes takes place. The overall performance of the circuit is thereby improved. Since the mixing frequency is determined by a detector, as being the center frequency of the stronger of at least two signals at respective frequencies, the circuit for estimating and correcting mismatch between in-phase and quadrature signals (and what is especially important the error signal calculator herein) is operating on the strongest signal, which may be the unwanted signal. Neighbor channel disturbance entering the automatic gain control element is thereby reduced. The dynamic range of the automatic gain control is reduced by a pair of low pass filters operating on the up-mixed regulated in-phase and quadrature signals, and a pair of low pass filters operating on the down-mixed regulated in-phase and quadrature signals. Since the AGC has a feed forward structure, stability is always given.

The basic idea is to modify the approaches as known from U.S. Pat. No. 5,230,099 and [1] for estimating and correcting mismatch between incoming in-phase and quadrature signals by:

combining the best performing errors signal ([1]) with the cheapest to implement correction system (U.S. Pat. No. 5,230,099);

letting the detector output a positive center frequency and a negative center frequency corresponding to a center frequency of the stronger of at least two signals at respective frequencies;

up-mixing and low pass filtering the regulated in-phase and quadrature signals, using the positive center frequency as mixing frequency;

down-mixing and low pass filtering the regulated in-phase and quadrature signals, using the negative center frequency as mixing frequency;

expanding the automatic gain control to operate on up-mixed filtered and down-mixed filtered regulated in-phase and quadrature signals;

expanding the error signal calculator to operate on up-mixed filtered normalized and down-mixed filtered regulated normalized in-phase and quadrature signals.

By a real frequency f shall be understood a center frequency detected by a detector.

By a positive center frequency shall be understood a complex center frequency that mathematically can be expressed as: A(cos 2πft+j sin 2πft), where f is a real frequency, t is time and A is an amplitude.

By a negative center frequency shall be understood a complex center frequency that mathematically can be expressed as: A(cos 2πft−j sin 2πft), where f is a real frequency, t is time and A is an amplitude.

An embodiment of the circuit for estimating and correcting mismatch between incoming in-phase and quadrature signals as disclosed in claim 2 has the advantages that the detector is able to find the strongest signal without any knowledge of the signal distribution, by scanning the frequency band until the strongest signal is found. This method may be preferred in applications where the signals are not distributed evenly, or in applications where the signal locations on the frequency band are generally not known.

An embodiment of the circuit for estimating and correcting mismatch between incoming in-phase and quadrature signals as disclosed in claim 3 has the advantages that, due to knowledge of the signal distribution at the frequency band, the detector can be implemented with fixed frequency band pass filters tuned to the center frequency of the individual signals. The strongest signal is found by selecting a fixed frequency band pass filters one at the time, until the strongest signal in the frequency band is found. This method may be preferred in applications where the signal distributed is known, as it is faster than scanning the frequency band. Also, the method can be implemented in applications, whether or not the signals are evenly distributed, if the signal distribution is known.

An embodiment of the circuit for estimating and correcting mismatch between incoming in-phase and quadrature signals as disclosed in claim 4 has the advantages that the detector can be implemented with two band pass filters, one band pass filter tuned to the center frequency of the wanted signal, and the other band pass filter tuned to the center frequency of the unwanted signal, and where the band pass filters operate in parallel and simultaneously. If in addition, the two center frequencies are known, the band pass filters may also be implemented as fixed frequency band pass filters. This implementation may be preferred, if the number of signals in the frequency band is known to be two at the maximum, as the implementation is very simple and the operation very fast. A typical implementation may be at the intermediate frequency (IF) in a receiver.

An embodiment of the circuit for estimating and correcting mismatch between incoming in-phase and quadrature signals as disclosed in claim 5 has the advantages that normalization can be performed without using feedback in the automatic gain control. The stability of the automatic gain control is thereby always granted, and thus the stability of the entire circuit is improved. Also this method is very simple to implement. This type of automatic gain controls will in general be preferred for applications where no or only a rough AGC is present.

An embodiment of the circuit for estimating and correcting mismatch between incoming in-phase and quadrature signals as disclosed in claim 6 has the advantages that the calculation of an amplitude error signal and a phase error signal are performed with improved accuracy, as the calculations are based on normalized signals. This improves the performance, and the stability, of the entire circuit.

An embodiment of the circuit for estimating and correcting mismatch between incoming in-phase and quadrature signals as disclosed in claim 7 has the advantages that the amplitude error signal and the phase error signal can be controlled independently in a very simple way, thus making it possible only to reset the loop filter in question operating on the error signal (amplitude or phase) outside a tolerable limit. It is thereby granted that the correction system, in case of a wrong estimation of mismatch, is not increasing the mismatch beyond a given limit. As the operation of the estimation control element is based on a first predefined limit and a second predefined limit, these predefined limits can be selected or adjusted to values for optimal performance. In example, these predefined limits can be adjusted each time the receiver is tuned to a signal in the frequency band.

An embodiment of the circuit for estimating and correcting mismatch between incoming in-phase and quadrature signals as disclosed in claim 8 has the advantages that the estimation control element can be implemented in a very simple way. As both the loop filter operating on the amplitude error signal and the phase error signal are reset, when either the amplitude error signal or the phase error signal (or both) are outside tolerable limits, this estimation control element can also be used for minimum correction systems requiring both the amplitude error signal and the phase error signal reset simultaneously. As the operation of the estimation control element is based on a first predefined limit and a second predefined limit, these predefined limits can be selected or adjusted to values for optimal performance. In example, these predefined limits can be adjusted each time the receiver is tuned to a signal in the frequency band.

An embodiment of the circuit for estimating and correcting mismatch between incoming in-phase and quadrature signals as disclosed in claim 9 has the advantages that high frequency analogue signals can be adapted to the circuit for estimating and correcting mismatch between incoming in-phase and quadrature signals. By the demodulation process, the frequency of the analogue signal is down-converted to an intermediate frequency manageable by the circuit. By the analogue-to-digital conversion process the down-converted analogue signal is converted to a pair of digital in-phase and quadrature signals, as required by the circuit. Since the analogue-to-digital converters and the analogue delays are time-delay compensated, the analogue-to-digital converters and the analogue delays are prevented from contributing to any mismatch between the incoming in-phase and quadrature signals.

An embodiment of the circuit for estimating and correcting mismatch between incoming in-phase and quadrature signals as disclosed in claim 10 has the advantages that the high frequency analogue signal is down-converted to a pair of analogue in-phase and quadrature signals operating at an intermediate frequency manageable by the circuit.

An embodiment of the circuit for estimating and correcting mismatch between incoming in-phase and quadrature signals as disclosed in claim 11, has the advantages, that the analogue in-phase and quadrature signals are converted to digital in-phase and quadrature signals, as required by the circuit. As the analogue-to-digital converters and the analogue delays are time-delay compensated, any tolerance in the circuit elements of the analogue-to-digital converters and the analogue delays are prevented from contributing to mismatch in the incoming in-phase and quadrature signals.

An embodiment of the circuit for estimating and correcting mismatch between incoming in-phase and quadrature signals as disclosed in claim 12 has the advantages that the dynamic range of the analogue-to-digital converters can optionally be reduced, or anti-aliasing filtering can be performed if a Nyquist analogue to digital converter is employed in place of a sigma delta converter.

An embodiment of the circuit for estimating and correcting mismatch between incoming in-phase and quadrature signals as disclosed in claim 13 has the advantages that a sigma-delta converter can be used as analogue-to-digital converter in applications requiring a sigma-delta converter, e.g. applications requiring high linearity.

An embodiment of the circuit for estimating and correcting mismatch between incoming in-phase and quadrature signals as disclosed in claim 14 has the advantages that an at least one bit analogue-to-digital converter can be used as converter in applications suitable for an at least one bit analogue-to-digital converter, e.g. applications operating at a low frequency. The number of bits can be selected as required by the application (and frequency).

An embodiment of the circuit for estimating and correcting mismatch between incoming in-phase and quadrature signals as disclosed in claim 15 has the advantages that the calculation becomes more accurate, since noise is reduced to the tuneable digital time-delay.

An embodiment of the circuit for estimating and correcting mismatch between incoming in-phase and quadrature signals as disclosed in claim 16 has the advantages that the need for compensating for measurement errors resulting from the first-phase mismatch estimating element and the second-phase mismatch estimating element are cancelled out, as the phase mismatch estimating elements are implemented by identical circuits. If the phase mismatch estimating elements are implemented on the same electronic chip, measurement errors resulting from temperature variation of the components may additionally be cancelled out.

These and other aspects of the invention will be apparent from and elucidated by reference to the embodiment(s) described hereinafter.

FIG. 1 shows a circuit for normalizing two complex signals; and

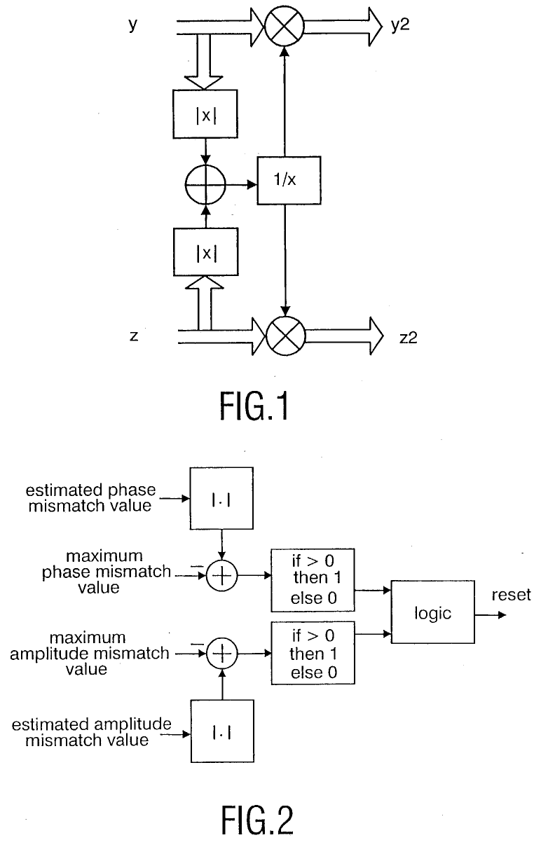

FIG. 2 shows a structure for an estimation control element; and

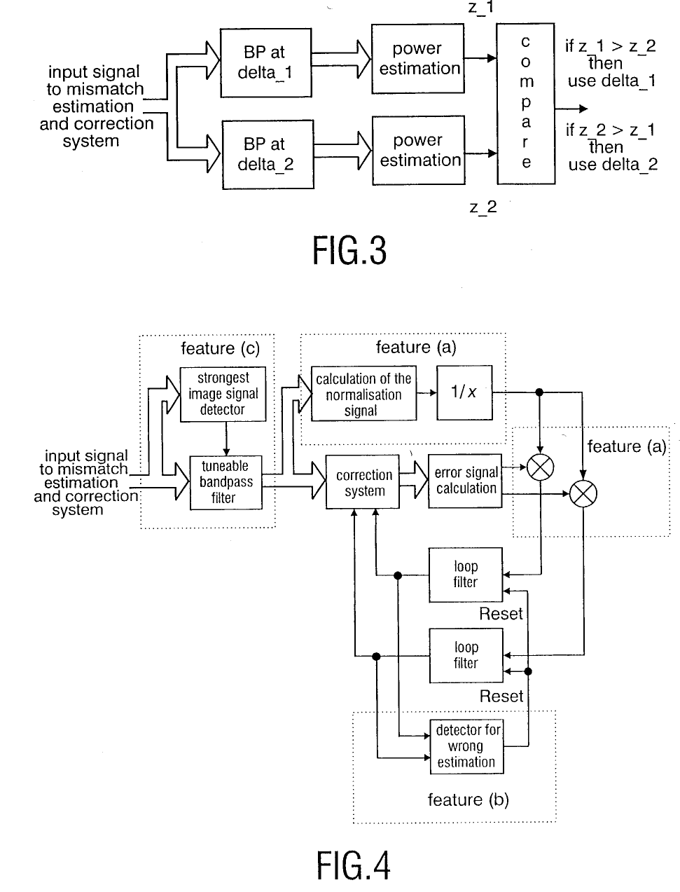

FIG. 3 shows a structure for a detector; and

FIG. 4 shows a circuit including the features discussed in FIG. 1 to 3; and

FIG. 5 shows a demodulating and digitalizing circuit element; and

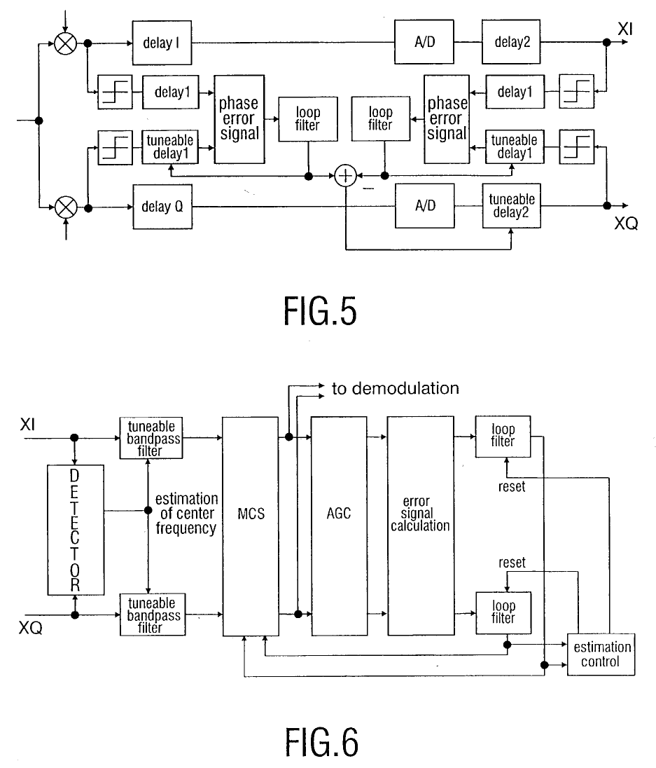

FIG. 6 shows a classical estimation and correction system having implemented the features of FIGS. 1, 2, 3 and 5; and

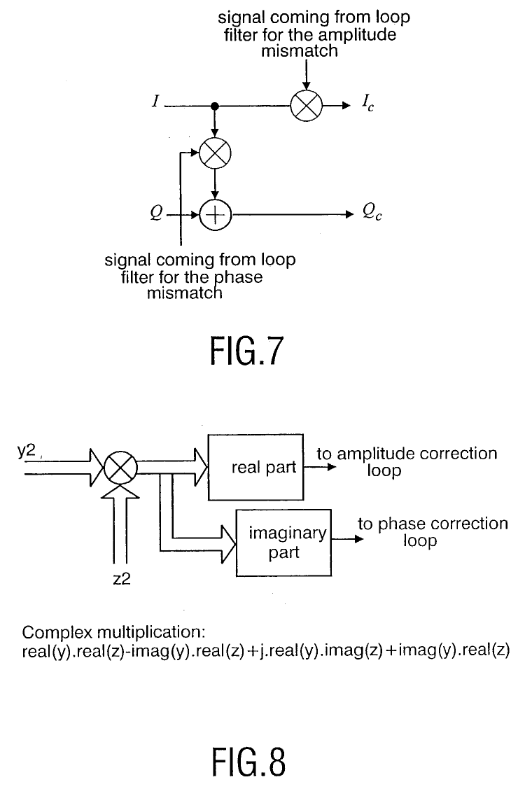

FIG. 7 shows a minimum correction system (MCS); and

FIG. 8 shows an error signal calculator; and

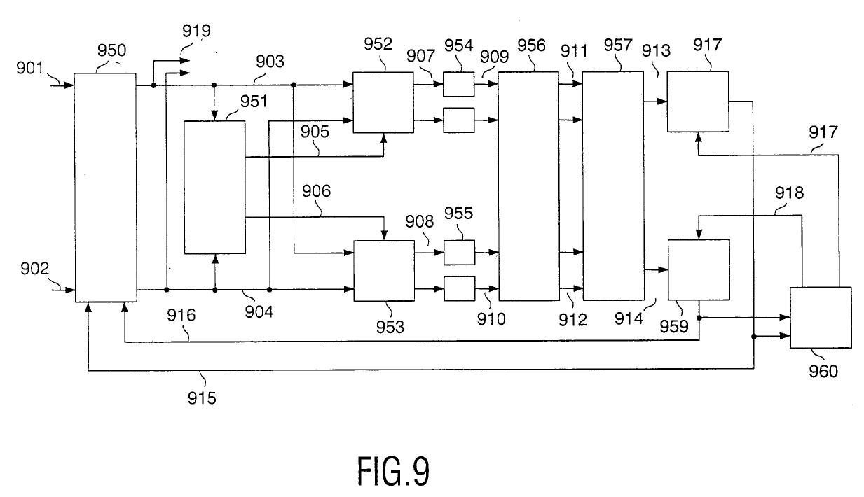

FIG. 9 shows a preferred embodiment of a circuit for estimating and correcting mismatch between incoming in-phase and quadrature signals, which is also the best mode of the invention.

In wireless communication systems, the transmitted signal is typically located at a certain frequency fRF. For the reception of such a signal it is mostly required to have the wanted signal at 0 Hz or at a frequency which is much smaller than fRF. This requires a mixing operation. A mixer is a device that shifts the received signal in frequency. The classic tuner designs employ two mixing stages. In a first mixing stage the signal is mixed to an intermediate frequency fIF. The basic principle of a mixer can be modeled in mathematical terms by a multiplication of the received signal with cos(2πfLOt), where fLO denotes the mixing frequency of the mixer. This operation implies that a receiver employing such a mixer will also receive a signal located at fRF−2fIF if fLO<fRF is valid, and if fLO>fRF, signals at fRF+2fIF are received. To counteract this unwanted effect different approaches can be taken.

The classic approach consists in filtering out the signal, which is located at fRF−2fIF (or fRF+2fIF) prior to mixing down the signal. Other approaches are based on a complex mixer structure, employing besides a multiplication of cos(2πfLOt) also a multiplication with sin(2πfLOt). In mathematical term, this results to a multiplication of the received signal with cos(2πfLOt)+j sin(2πfLOt). Since this operation has to be implemented by analogue components, it is not possible to implement it perfectly. A good model is given by cos(2πfLOt)+jλ sin(2πfLOt+θ), where λ models an amplitude mismatch and θ a phase mismatch.

The problem consists in making λ equal to one and θ equal to zero. One approach to make λ equal to one and θ equal to zero consists in setting up an estimation system that estimates the mismatch of phase and amplitude, and employing a correction system that corrects the errors introduced through the imperfect mixer after the mixing operation.

The invention differs from the classic system by:

employing normalization for the system; and

employing an estimation control element, which prevents the estimation and correction system from introducing additional errors; and

employing a detector to improve the system performance based on analysis of the underlying theory; and

combining elements out of known approaches to obtain the best possible performance while keeping implementation costs low.

Normalization is required to allow functioning of the system in the presence of power changes of the received signal. There are systems that employ automatic gain control (AGC) loops to keep the received signal strength for the internal processing in certain boundaries. But AGC loops also have drawbacks. Therefore, they are not always included. A change of the received signal power leads directly to a change in the amplitude of the error-signals. A change of the amplitude of the error-signal affects the loop gain, which affects the loop performance with respect to accuracy and velocity. Furthermore, the stability margin of the loop is changed. All these system parameters have to be constant to achieve the required performance. By employing normalization of the error-signal, this can be achieved.

An estimation control element is required to prevent the mismatch estimation and correction system from introducing additional errors. The combination of theoretical results, simulations, and measurements leads to the conclusion that the estimation and correction systems are not going to reduce the phase and amplitude mismatch beyond what is already achieved through careful layout of the mixer if a signal located in the image band and the wanted signal are of equal strength. It is even more possible that, especially in this situation, the mismatch estimation and correction system will introduce additional amplitude and phase mismatch. An estimation control element is employed to keep this added amplitude and phase error within narrow limits. This is achieved by monitoring the estimated mismatch values for phase and amplitude. If a certain value is exceeded (the threshold is related to the mismatch typically achieved by the analogue implementation), the estimation and correction system undergoes a reset.

Exploring the fact that the performance of the mismatch estimation and correction system depends on the power ratio between a signal located in the image band and the wanted signal leads to employing a detector for detecting and outputting a center frequency of the stronger of two signals at respective frequencies. By maximizing the power ratio, the performance in terms of image rejection ratio can be improved by several dB.

FIG. 1 illustrates a circuit for normalizing two complex signals. The two complex signals will typically be up-mixed in-phase and quadrature signals mixed with a positive center frequency, and down-mixed in-phase and quadrature signals mixed with a negative center frequency. The normalization is employed by dividing each of the in-phase and quadrature signals by the sum of the absolute values of the in-phase and quadrature signals.

FIG. 2 illustrates the structure for an estimation control element. If the phase mismatch estimation or the amplitude mismatch estimation exceeds a threshold, a ‘1’ signal is generated and used as an input of a logic device. This can be an AND function, leading to a reset of the loop filters in the estimation and correction system if both thresholds (for amplitude and phase) are exceeded or by an OR function if only one threshold is exceeded.

The idea behind the detector illustrated in FIG. 3 is to maximize the power ratio between the wanted signal and an unwanted one located in the image band. To achieve this, only certain spectral parts of the received signal have to be filtered out, namely those where the most energy is located in the image band. Depending on the type of the system, a signal in the image band can be located at certain places due to the channel distance of the system or everywhere, if there is no fixed channel separation. In FIG. 3, a detector is shown for a system where only two locations of a signal in the image band are possible (e.g. FM radio). Two band pass filters are used to filter out the signal components around Δ1 and Δ2. At the output of the two filters the power of the filtered output signal is estimated. A comparison of the output power is then used to set the center frequency of the tuneable band pass filter equal to Δ1 or to Δ2. Since the frequencies Δ1 and Δ2 are not equal to the center frequency of the wanted signal, the corrected signal available after the correction block cannot be taken for the demodulation of the wanted signal. As a consequence, a second correction has to be accomplished having as an input signal the output of a band pass filter filtering out a band of frequencies centered around the center frequency of the wanted signal.

FIG. 4 illustrates a circuit including the features discussed, FIG. 1 to 3.

FIG. 5 illustrates how a relative delay difference D given by delay I−delay Q not being equal to zero can be estimated and corrected in a demodulating and digitalizing circuit element. Delay 1 is required to compensate for the delay of the tuneable delay blocks, which is present even if the delay I−delay Q=0 is valid. The estimation based on the input signals of delay I and delay Q is required, since a phase mismatch in the signals driving the mixer disturbs the phase error signal generation. Therefore, the estimation at the input of delay I and delay Q is used as a kind of reference. If, after the signal processing steps (e.g. delay I and delay Q could represent a filter and the A/D converters also may introduce a delay), the second phase estimation based on the output signal of delay 2 and tuneable delay 2 is different from the reference estimation before, a relative delay mismatch has occurred. Delay 2 is again required to compensate for the inherent delay of the tuneable delay 2. The following FIG. 6 and FIG. 9 have the output signals XI and XQ as input signals.

FIG. 6 illustrates a classic estimation and correction system having implemented the features of FIGS. 1, 2, 3 and 5. Normalization is given by the automatic gain control loop (AGC). The AGC can be placed before or after the error signal calculation block. The estimation control is given by the estimation control element. If the estimated mismatch becomes too large, a reset of the loop filters is performed. The detector identifies the stronger of two signals. In the most general case, this detector has to detect in the frequency band of interest that frequency y, which maximizes at the output of a real band-pass filter with center frequency y the power ratio between an unwanted signal and a wanted signal component. In most of the cases this scan operation is equal to looking for the frequency component containing the highest energy. This frequency is then used as a center frequency for the following band-pass filter.

FIG. 7 illustrates a minimum correction system (MCS). The amplitude mismatch is corrected by multiplying the in-phase signal with the amplitude error signal. The phase mismatch is corrected by adding the in-phase signal multiplied by the phase error signal to the quadrature signal. At the boundary, where λ=1 (the amplitude error signal) and θ=0 (the phase error signal), the incoming in-phase and quadrature signals equal the regulated in-phase and quadrature signals.

FIG. 8 illustrates an error signal calculator. The amplitude error signal is calculated as the real part of the complex number multiplication of the up-mixed normalized regulated in-phase and quadrature signals and the down-mixed normalized regulated in-phase and quadrature signals. The phase error signal is calculated as the imaginary part of the complex number multiplication of the up-mixed normalized regulated in-phase and quadrature signals and the down-mixed normalized regulated in-phase and quadrature signals.

FIG. 9 illustrates a preferred embodiment of a circuit for estimating and correcting mismatch between incoming in-phase and quadrature signals, which is also the best mode of the invention. 901 is an in-phase branch of incoming in-phase and quadrature signals. 902 is a quadrature branch of the incoming in-phase and quadrature signals. 903 is an in-phase branch of regulated in-phase and quadrature signals. 904 is a quadrature branch of the regulated in-phase and quadrature signals. 905 is a positive center frequency. 906 is a negative center frequency. 907 is up-mixed regulated in-phase and quadrature signals. 908 is down-mixed regulated in-phase and quadrature signals. 909 is low pass filtered up-mixed regulated in-phase and quadrature signals. 910 is low pass filtered down-mixed regulated in-phase and quadrature signals. 911 is normalized low pass filtered up-mixed regulated in-phase and quadrature signals. 912 is normalized low pass filtered down-mixed regulated in-phase and quadrature signals. 913 is an amplitude error signal. 914 is a phase error signal. 915 is a low pass filtered amplitude error signal. 916 is a low pass filtered phase error signal. 917 is an amplitude loop filter reset signal. 918 is a phase loop filter reset signal. 919 is a possible further connection of the regulated in-phase and quadrature signals to a demodulator. 950 is a minimum correction system. 951 is a detector for detecting the stronger of at least two signals. 952 is a mixer for up-mixing the regulated in-phase and quadrature signals. 953 is a mixer for down-mixing the regulated in-phase and quadrature signals. 954 is a first pair of low pass filters. 955 is a second pair of low pass filters. 956 is an automatic gain control element for normalizing low pass filtered up-mixed regulated in-phase and quadrature signals 909, and low pass filtered down-mixed regulated in-phase and quadrature signals 910. 957 is an error signal calculator. 958 is a first loop filter. 959 is a second loop filter. 960 is an estimation control element.

In FIG. 9, the normalization is given by the automatic gain control (AGC), normalizing up-mixed regulated in-phase and quadrature signals and normalizing down-mixed regulated in-phase and quadrature signals. The normalizing element can be placed before or after the error signal calculator. If the normalizing element is placed behind, the function stays the same, but implementation is slightly different—for normalizing the square in place of the absolute value has to be used. The estimation control is given by the estimation control element. If the estimated mismatch becomes too large, a reset of the loop filters is performed. The detector identifies the stronger of two signals. In the most general case, this detector has to detect in the frequency band of interest that frequency y, which maximizes at the output of a real band-pass filter with center frequency y the power ratio between an unwanted signal and a wanted signal component. In most of the cases this scan operation is equal to looking for the frequency component containing the highest energy. This frequency is then used as a center frequency for the following mixers. Now this frequency is once used with a positive sign for up-mixing, and once used with a negative sign for down-mixing (note the mixers are complex, therefore it is possible to distinguish between positive and negative frequencies).

For a proper selected intermediate frequency, and a low-IF system FM radio system, the number of frequencies is limited to two. This results from the channel distance of FM radio channels and the receiver properties.

If the band-pass filtering is accomplished in such a way that demodulation of the wanted signal is still possible (note: demodulation of the wanted signal and estimation and correction of mismatch are two different things that are not always easy to combine), the demodulation of the signal can be carried out based on the output signal of the minimum correction system (MCS). If the band pass filtering does not allow demodulation, a second MCS system has to be used to correct XI and XQ before band-filtering and using the output signal for demodulation. It is also possible to use only one MCS system before band-pass filtering. It this case the tuneable band pass filter becomes part of the loop and thereby introduces an extra loop delay.

1. A circuit for estimating and correcting mismatch between incoming in-phase and quadrature signals, the circuit comprising:
a detector for detecting a center frequency of the stronger of at least two signals at respective frequencies;
an automatic gain control element for receiving and normalizing low-pass filtered up-mixed regulated in-phase and quadrature signals and for receiving and normalizing low-pass filtered down-mixed regulated in-phase and quadrature signals;
an error signal calculator for calculating an amplitude error signal and for calculating a phase error signal from the normalized low-pass filtered up-mixed regulated in-phase and quadrature signals and from the normalized low-pass filtered down-mixed regulated in-phase and quadrature signals;
a first loop filter for low pass filtering the amplitude error signal;
a second loop filter for low pass filtering the phase error signal;
a minimum correction system for correcting the amplitude and phase of in-phase and quadrature signals, the minimum correction system receiving the low pass filtered amplitude error signal, and the minimum correction system receiving the low pass filtered phase error signal;
an estimation control element for receiving the low pass filtered amplitude error signal and for receiving the low pass filtered phase error signal, the estimation control element for resetting, if the amplitude error signal reaches a first predefined limit, at least the filter filtering the amplitude error signal, and for resetting, if the phase error signal reaches a second predefined limit, at least the filter filtering the phase error signal,
characterized in that said detector is adapted for outputting a positive center frequency and outputting a negative center frequency corresponding to said detected center frequency, and said minimum correction system is adapted for correcting the amplitude and phase of the incoming in-phase and quadrature signals to form the regulated in-phase and quadrature signals, and the circuit comprises:
a first mixer for up-mixing regulated in-phase and quadrature signals with a positive center frequency outputted from the detector;
a second mixer for down-mixing the regulated in-phase and quadrature signals with a negative center frequency outputted from the detector;
a first pair of low-pass filters for receiving and filtering the up-mixed regulated in-phase and quadrature signals;
a second pair of low-pass filters for receiving and filtering the down-mixed regulated in-phase and quadrature signals.

2. A circuit for estimating and correcting mismatch between incoming in-phase and quadrature signals according to claim 1, characterized in that said detector is adapted, when tuning a band pass filter to the frequency of said signal, to detect the signal and to output the center frequency.

3. A circuit for estimating and correcting mismatch between incoming in-phase and quadrature signals according to claim 1, characterized in that said detector is adapted, when selecting a fixed frequency band pass filter at the frequency of said signal, to detect the signal, and the fixed frequency band pass filter is selected from among at least one fixed frequency band pass filter, and the selectable fixed frequency band pass filters are of at least one respective frequency, and the detector outputs the center frequency.

4. A circuit for estimating and correcting mismatch between incoming in-phase and quadrature signals according to at least one of the claims 1 to 3, characterized in that said detector detects and outputs a center frequency of the stronger of two signals at respective frequencies, where one signal is a wanted signal and the other signal is an unwanted signal.

5. A circuit for estimating and correcting mismatch between incoming in-phase and quadrature signals according to at least one of the claims 1 to 4, characterized in that:
normalizing of said low-pass filtered up-mixed regulated in-phase and quadrature signals is performed by said automatic gain control element by dividing the low-pass filtered up-mixed regulated in-phase and quadrature signals by the sum of the absolute value of the low-pass filtered up-mixed regulated in-phase and quadrature signals; and the absolute value of the low-pass filtered down-mixed regulated in-phase and quadrature signals, and
normalizing of said low-pass filtered down-mixed regulated in-phase and quadrature signals is performed by said automatic gain control element by dividing the low-pass filtered down-mixed regulated in-phase and quadrature signals by the sum of the absolute value of the low-pass filtered up-mixed regulated in-phase and quadrature signals, and the absolute value of the low-pass filtered down-mixed regulated in-phase and quadrature signals.

6. A circuit for estimating and correcting mismatch between incoming in-phase and quadrature signals according to at least one of the claims 1 to 5, characterized in that:
said amplitude error signal is calculated by said error signal calculator as the real part of the complex number multiplication of said normalized low-pass filtered up-mixed regulated in-phase and quadrature signals, and said normalized low-pass filtered down-mixed regulated in-phase and quadrature signals; and
said phase error signal is calculated by said error signal calculator as the imaginary part of the complex number multiplication of said normalized low-pass filtered up-mixed regulated in-phase and quadrature signals, and said normalized low-pass filtered down-mixed regulated in-phase and quadrature signals.

7. A circuit for estimating and correcting mismatch between incoming in-phase and quadrature signals according to at least one of the claims 1 to 6, characterized in that said estimation control element for resetting, if the result from subtracting said first predefined limit from the absolute value of said low pass filtered amplitude error signal yields a positive result, at least the filter filtering the amplitude error signal, and for resetting, if the result from subtracting said second predefined limit from the absolute value of said low pass filtered phase error signal yields a positive result, at least the filter filtering the phase error signal.

8. A circuit for estimating and correcting mismatch between incoming in-phase and quadrature signals according to claim 7, characterized in that said estimation control element for resetting the filter filtering the amplitude error signal and the filter filtering the phase error signal, if the value from logically OR'ing the result from subtracting said first predefined limit from the absolute value of said low pass filtered amplitude error signal with the result from subtracting said second predefined limit from the absolute value of said low pass filtered phase error signal yields a positive result.

9. A circuit for estimating and correcting mismatch between incoming in-phase and quadrature signals according to at least one of the claims 1 to 8, characterized in that said incoming in-phase and quadrature signals are supplied from a demodulating and digitalizing circuit element comprising:
an analogue signal demodulator for receiving and demodulating an analogue signal, and for outputting demodulated analogue in-phase and quadrature signals;
a pair of time-delay compensated analogue-to-digital converters for receiving, analogue-to-digital converting, and time-delay compensating the demodulated analogue in-phase and quadrature signals to incoming in-phase and quadrature signals.

10. A circuit for estimating and correcting mismatch between incoming in-phase and quadrature signals according to claim 9, characterized in that said analogue signal demodulator comprises:
a multiplier multiplying said analogue signal by a cosine wave, the cosine wave being outputted from an oscillator,
a multiplier multiplying said analogue signal by a sine wave, the sine wave being outputted from an oscillator operating at the same frequency as the cosine wave oscillator.

11. A circuit for estimating and correcting mismatch between incoming in-phase and quadrature signals according to claim 9 or 10, characterized in that said pair of time-delay compensated analogue-to-digital converters comprise:
a first phase mismatch estimating element receiving said demodulated analogue in-phase and quadrature signals and estimating and outputting a first phase mismatch between the demodulated analogue in-phase and quadrature signals;
a second phase mismatch estimating element receiving said incoming in-phase and quadrature signals and estimating and outputting a second phase mismatch between the incoming in-phase and quadrature signals;
a subtracting element outputting a tuning signal, where the tuning signal is calculated as the first phase mismatch minus the second phase mismatch;
a first analogue time-delay in series with a first analogue-to-digital converter in series with a first digital time-delay having a first branch of said demodulated analogue in-phase and quadrature signals as input signal and having a first branch of said incoming in-phase and quadrature signals as output signal;
a second analogue time-delay in series with a second analogue-to-digital converter in series with a first tuneable digital time-delay having a second branch of said demodulated analogue in-phase and quadrature signals as input signal and having a second branch of said incoming in-phase and quadrature signals as output signal, the tuneable digital time-delay being tuned by the tuning signal.

12. A circuit for estimating and correcting mismatch between incoming in-phase and quadrature signals according to claim 11, characterized in that said first analogue time-delay is a low-pass filter and said second analogue time-delay is a low-pass filter.

13. A circuit for estimating and correcting mismatch between incoming in-phase and quadrature signals according to claim 11 or 12, characterized in that said first analogue-to-digital converter is a sigma-delta converter, and said second analogue-to-digital converter is a sigma-delta converter.

14. A circuit for estimating and correcting mismatch between incoming in-phase and quadrature signals according to claim 11 or 12, characterized in that said first analogue-to-digital converter is an at least one bit analogue-to-digital converter, and said second analogue-to-digital converter is an at least one bit analogue-to-digital converter.

15. A circuit for estimating and correcting mismatch between incoming in-phase and quadrature signals according to at least one of the claims 11 to 14, characterized in that said tuning signal outputted form said subtracting element is low pass filtered before it becomes an input to said tuneable digital time-delay.

16. A circuit for estimating and correcting mismatch between incoming in-phase and quadrature signals according to at least one of the claims 11 to 14, characterized in that said first phase mismatch estimating element comprises:
a first one-bit analogue-to-digital converter in series with a third analogue time-delay having said first branch of said demodulated analogue in-phase and quadrature signals as input signal and a first digital signal as output signal;
a second one-bit analogue-to-digital converter in series with a tuneable analogue time-delay having said second branch of said demodulated analogue in-phase and quadrature signals as input signal, and a second digital signal as output signal, the tuneable analogue time-delay being tuned by said first phase mismatch;
a first multiplying element receiving and multiplying the first digital signal and the second digital signal outputting a third digital signal,
a low pass filter receiving and filtering the third digital signal and outputting the first phase mismatch,
and said second phase mismatch estimating element comprising of:
a third one-bit analogue-to-digital converter in series with a second digital time-delay having said first branch of said incoming in-phase and quadrature signals as input signal and a fourth digital signal as output signal;
a fourth one-bit analogue-to-digital converter in series with a second tuneable digital time-delay having said second branch of said incoming in-phase and quadrature signals as input signal, and a fifth digital signal as output signal, the second tuneable digital time-delay being tuned by said second phase mismatch;
a second multiplying element receiving and multiplying the fourth digital signal and the fifth digital signal outputting a sixth digital signal;
a low pass filter, receiving and filtering the sixth digital signal, and outputting the second phase mismatch.
